(19) United States
(12) Patent Application Publication
(10) Pub. No.: US 2018/0154291 A1
(43) Pub. Date: Jun. 7, 2018

(54) Disk Filter Segment for a Collector

(71) Applicant: A. Malo Compagnie Limitee, Joliette (CA)

(72) Inventor: Gilles Malo, Saint-Charles-Borromee (CA)

(21) Appl. No.: 15/831,299

(22) Filed: Dec. 4, 2017

Related U.S. Application Data
(60) Provisional application No. 62/429,441, filed on Dec. 2, 2016.

(51) Int. Cl. B01D 33/23; B01D 33/00

(52) U.S. Cl. CPC B01D 33/23; B01D 2201/12; B01D 33/0093

(57) ABSTRACT

The invention is directed to a disk segment for a collector typically used in the paper industry. The segment comprises a frame, at least one radially extending rib and at least one transversal rib, the at least one longitudinal rib and the at least one transversal rib being preferably supported by the frame. The transversal rib is preferably substantially perpendicular to the radially extending rib. The disk segment defining two surfaces adapted to receive a mesh that lay over the radially and transversal ribs. The longitudinal rib preferably has a “U”-shape or “S”-shape. The longitudinal rib also preferably defines cavities adapted to receive the transverse ribs thus allowing a mesh surface to lay flat on the segment. Such embodiment has the objective to improve the efficiency of the filter. The mesh, preferably made of metal, is also attached using spot welding and has the objective to facilitate its replacement.

### CROSS-REFERENCE TO RELATED APPLICATIONS

The present patent application claims the benefits of priority of U.S. Provisional Patent Application No. 62/429,441, entitled “Disk Filter Segment for a Collector”, and filed at the United States Patent and Trademark Office on Dec. 2, 2017, the content of which is incorporated herein by reference.

### FIELD OF THE INVENTION

The present invention generally relates to disk filter for separation of liquids from suspension particles. More specifically, the invention relates to disk filters used in the paper industry.

### BACKGROUND OF THE INVENTION

Disk filters have been known in the art for a long time. Some examples include the prior art systems disclosed in patent documents U.S. Pat. No. 3,485,376, U.S. Pat. No. 8,801,929, U.S. Pat. No. 8,852,434 and US 2005/0082217.

Typically, systems for separating liquids from particles comprise a plurality of axially spaced disks on a rotating axle. A portion of the disk is then submerged in a liquid containing suspension particles. Each disk typically comprises a plurality of disk segments comprising mesh surfaces and inner channels. The liquid passing through the mesh are then routed to the central axle through the channels where they are forwarded on a conveyor. The particles generally remain on the mesh.

The device disclosed in patent U.S. Pat. No. 3,485,376 comprises a plurality of filter members mounted to a frame. The construction is complex and subject to regular maintenance.

Prior art disk segments present various drawbacks. For instance, the segment discloses in patent U.S. Pat. No. 8,852,434 is attached to the central axle using a long rod which may be unstable when dealing with heavier material. The device also comprises only one rib. There is thus no rib to guide the liquid toward the central axle.

The device disclosed in patent U.S. Pat. No. 8,801,929 comprises a structure that may be complex and expensive to manufacture. The filter media is also manufactured using mould and the frame is injected into the mould. The fabrication of the disk filter segment comprises many steps and is believed to be expensive.

The device disclosed in patent application US 2005/0082217 comprises outer walls made of pleated filter cloth to create ridges. Such device is believed to present a low fatigue resistance and high maintenance costs.

There is thus a need to provide an improved disk segment aiming at mitigating the disadvantages of prior art systems.

### SUMMARY OF THE INVENTION

The invention is directed to a disk segment operatively mounted to an axle of a rotary filter used to filter suspensions from a fluid, the disk segment defining a front filtering surface and a rear filtering surface and comprising:
a frame surrounding the front and rear filtering surfaces;
at least one radial rib supported by the frame and defining a channel for guiding filtered liquid toward the axle; and
filtering members operatively mounted on the front and rear filtering surfaces.

In a preferred embodiment, the frame comprises two radial frame members mounted on a support member, such as a support plate, and a transversal frame member supported by the two radial frame members.

Still in accordance with a preferred embodiment, the disk segment further comprises at least one transversal rib supported by the two radial frame members preferably and substantially perpendicular to the radial rib. It may also be partially supported by the radial rib.

The filtering members are preferably meshes made of metal. The meshes lay over the front and rear filtering surfaces as to cover the ribs. To provide substantially flat filtering surfaces, the radial rib defines a cavity whose depth substantially matches the thickness of the transversal rib. Such embodiment aims at improving the filtering efficiency of the disk segment.

In a preferred embodiment, the radial rib may have an “S”-shape or a “U”-shape cross-section. Such shape allows the liquid to slide along a radial direction toward the axle of the disk segment in both direction of rotation.

In a preferred embodiment, the meshes are attached to the filtering surfaces using means know in the art such as, but not limited to, spot welding, fastening or riveting.

The invention is also directed to a filtering system comprising the disk segment as described herein.

The invention is further directed to a maintenance method of a disk filter segment. The method comprising the steps of optionally removing the disk filter segment from the shaft, removing the mesh surface, a shrinking material membrane or any other type of mesh surface from the disk filter segment, installing a mesh surface according to the principles of the present invention by sliding the radial mesh frame members of the mesh surface on to the segment from the base plate towards the transversal frame member. The method may further comprise hooking the radial mesh frame members to the frame and tightening the mesh surface to the segment when the mesh surface is forced up in the direction from the base plate 106 towards the transversal frame member,

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of a first embodiment of a disk filter segment in accordance with the principles of the present invention.

FIG. 2 is a front view of the disk filter segment of FIG. 1.

FIG. 3 is a side view of the disk filter segment of FIG. 1.

FIG. 4 is a section view along line C-C of FIG. 2 showing a Z-shape cross-section.

FIG. 5 is an enlarged view of the area surrounded by the circle A of FIG. 1.

FIG. 6 is an enlarged view of the area surrounded by the circle B of FIG. 1.

FIG. 7 is a perspective view of a second embodiment of a disk filter segment in accordance with the principles of the present invention.

FIG. 8 is a front view of the disk filter segment of FIG. 7.

FIG. 9 is a side view of the disk filter segment of FIG. 7.

FIG. 10 is a section view along line F-F of FIG. 8 showing a U-shape cross-section.

FIG. 11 is an enlarged view of the area surrounded by the circle D of FIG. 7.

FIG. 12 is an enlarged view of the area surrounded by the circle E of FIG. 7.

FIG. 13 is a perspective view of the disk segment of FIG. 7, comprising the mesh surface, in accordance with the principles of the present invention.

FIG. 14 is a section view along line G-G of FIG. 13.

FIG. 15 is an enlarged view of the area surrounded by the circle H of FIG. 14.

FIG. 16 is an exploded perspective view of a disk filter segment in accordance with the principles of the present invention.

FIG. 17 is an exploded perspective view of a disk filter segment in accordance with the principles of the present invention.

FIG. 18A is a perspective view of a disk filter segment comprising a mesh in accordance with the principles of the present invention.

FIG. 18B is a front view of the disk filter segment of FIG. 18A.

FIG. 18C is a side view of the disk filter segment of FIG. 18A.

FIG. 18D is a bottom view of the disk filter segment of FIG. 18A.

FIG. 18E is a section view along line C-C of FIG. 18B.

FIG. 18F is an enlarged view of the area surrounded by the circle D of FIG. 18E.

FIG. 19A is a front view of the disk filter segment in accordance with the principles of the present invention.

FIG. 19B is a side view of the disk filter segment of FIG. 19A.

FIG. 19C is a bottom view of the disk filter segment of FIG. 19A.

FIG. 19D is a section view along line A-A of FIG. 19A.

FIG. 19E is an enlarged view of the area surrounded by the circle B of FIG. 19D.

FIG. 20A is a top view of an embodiment of a radial rib in Z-shape.

FIG. 20B is a section view of the radial rib in Z-shape of FIG. 20A.

FIG. 21A is a top view of an embodiment of a radial rib in U-shape.

FIG. 21B is a section view of the radial rib in U-shape of FIG. 21A.

FIG. 22 is a perspective view of a mesh being installed on a disk filter segment.

### DETAILED DESCRIPTION OF THE PREFERRED EMBODIMENT

A novel disk filter segment for a collector will be described hereinafter. Although the invention is described in terms of specific illustrative embodiments, it is to be understood that the embodiments described herein are by way of example only and that the scope of the invention is not intended to be limited thereby.

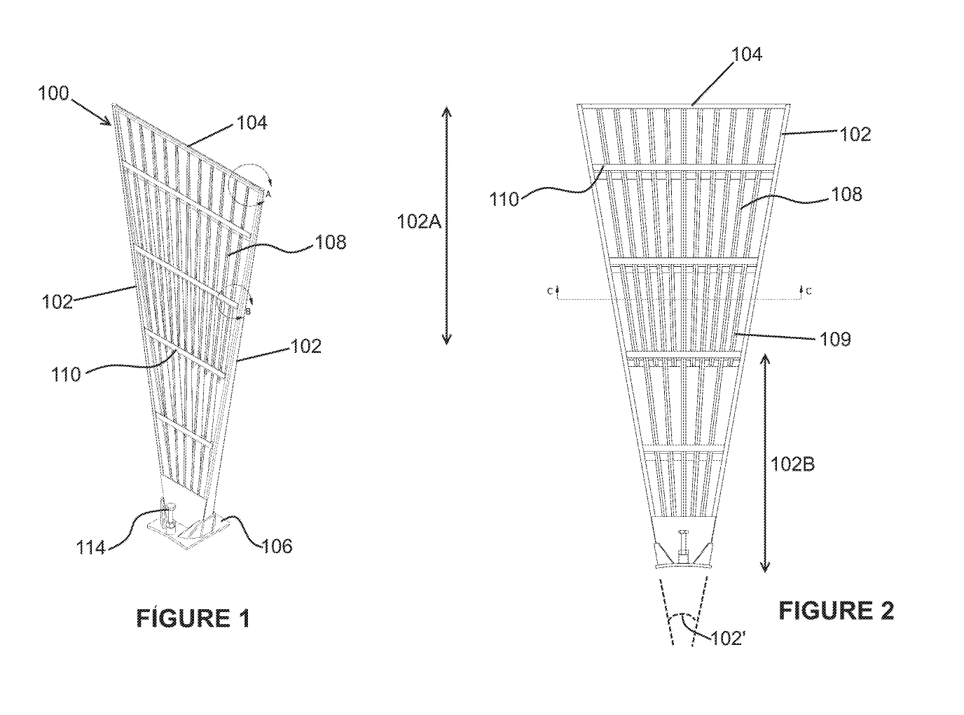

FIGS. 1 to 6, 20A and 20B illustrate a first embodiment of a disk filter segment 100. Such embodiment is typically adapted to receive an at least semi-rigid filtering mean. The semi-rigid filtering mean may be embodied as a mesh of metal or any other semi-rigid or rigid material. The segment 100 comprises a frame, comprising two longitudinally extending or radial frame members 102 and a laterally extending or transversal frame member 104. Both extremities of the transversal frame member 104 are preferably each operatively connected to an extremity of a radial frame member 102. The radial members 102 are also mounted on a support member, such as a base plate 106 and form an angle 102′. The angle 102′ varies based on the number of disk segments 100 present on a disk. The plate 106 is used to mount the segment 100 to a center axle preferably using fasteners such as bolts 114 and/or radial rods.

The segment 100 also comprises at least one radial rib 108 and at least one transversal rib 110. The radial rib 108 is preferably connected to the member 104 and to the base plate 106. The transversal ribs 110 are preferably connected to both radial frame members 102, aiming at providing structural rigidity to the segment 100.

To further provide rigidity, it may be necessary to add supplementary radial ribs, or sub-ribs 109 in an upper portion 102A of the disk segment 100. The sub-ribs 109 preferably have a first extremity attached to the transversal frame member 104 and the other extremity attached to a transversal rib 110. The sub-ribs 109 preferably do not extend through the bottom portion 102B.

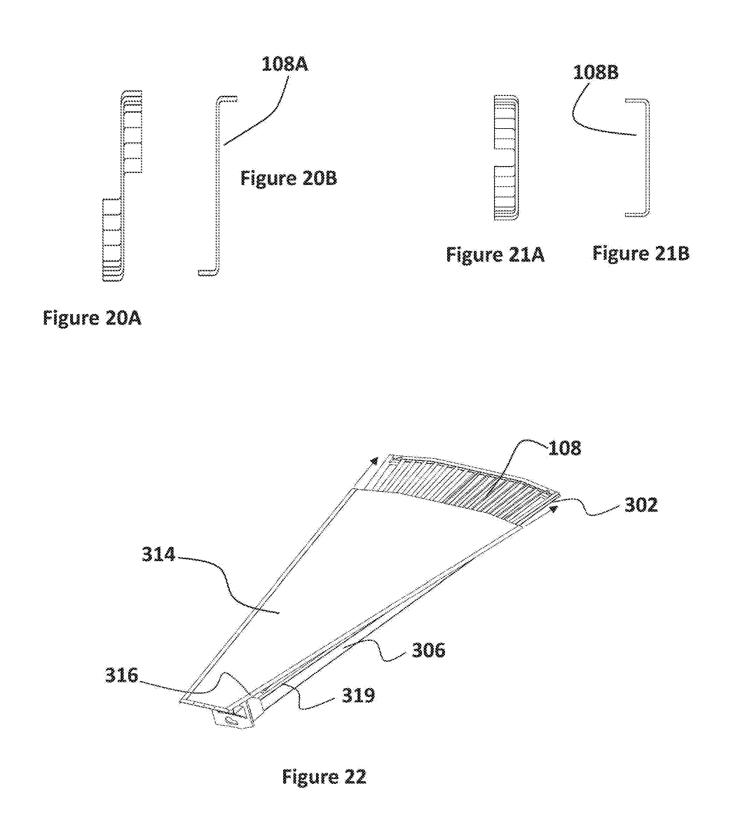

Referring to FIGS. 20A and 20B, an embodiment of the radial ribs 108 preferably have a “Z”-shape or an “S”-shape cross-section to allow using the disk segment 100 in both clockwise and counter clockwise direction. The “Z”-shape cross-section may also aim at easing spot welding. The radial members 102 preferably have a “U”-shape defining a cavity for receiving the extremities of the ribs 110 (see FIG. 1). The transversal member 104 also preferably has a “U”-shape cross-section defining a cavity for receiving the extremities of the ribs 108.

Referring more specifically to FIG. 6, the radial ribs 108 each preferably defines a recess, or concave portion 112 whose depth substantially correspond to the thickness of the transversal ribs 110. Such recess 112 allows the filtering surfaces 100A and 100B defined by both sides of the segment 100 to be substantially flat. Such embodiment aims at facilitating the installation of the mesh surface (not shown) on the filtering surface 100A and 100B and thus at improving the filtering efficiency of the segment 100.

In some embodiments, the radial ribs 108 may extend from the base of the disk segment 100 up to the top transversal frame member 104. In other embodiments, the radial ribs 108 may be shorter and extend between one of the transversal ribs 110 up to he top transversal frame member 104. p The radial and transversal ribs 108-110 are preferably attached to the radial and transversal frame members 102-104 by any suitable means known in the art, such as, but not limited to, fastening, welding, or riveting. Also, the transversal ribs 110 may be attached at intermediate positions inside the recess 112 of the radial ribs 108 for better rigidity. Any mean known in the art may be used for that purpose.

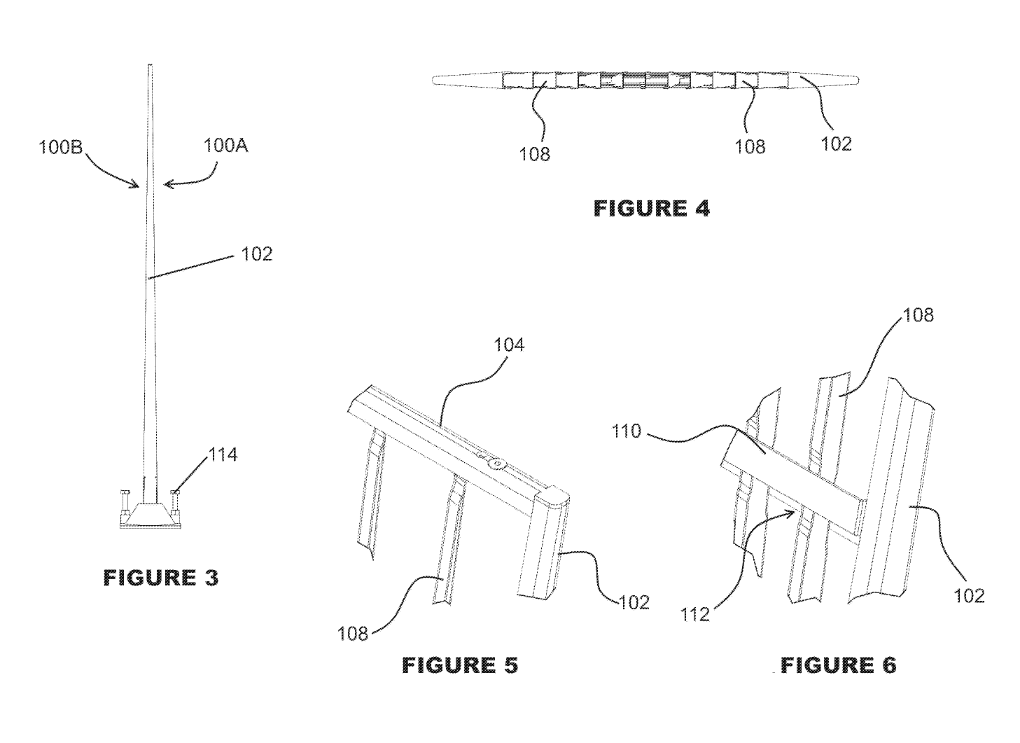

Referring more specifically to FIG. 3, the plate 106 of the segment 100 is preferably mounted to a central axle using fasteners such as bolts 114.

It is to be noted that the segment may comprise more or less radial ribs 108 and more or less transversal ribs 110 than illustrated in the figures without departing from the scope of the present invention.

Still referring to FIG. 3, the radial members 102 may be tapered. Such tapered shape aims at creating a larger volume toward the shaft as more liquid flows closer to the bottom portion of the disk segment. In other embodiments, the radial members 102 may have other shapes, such as being straight from top to bottom.

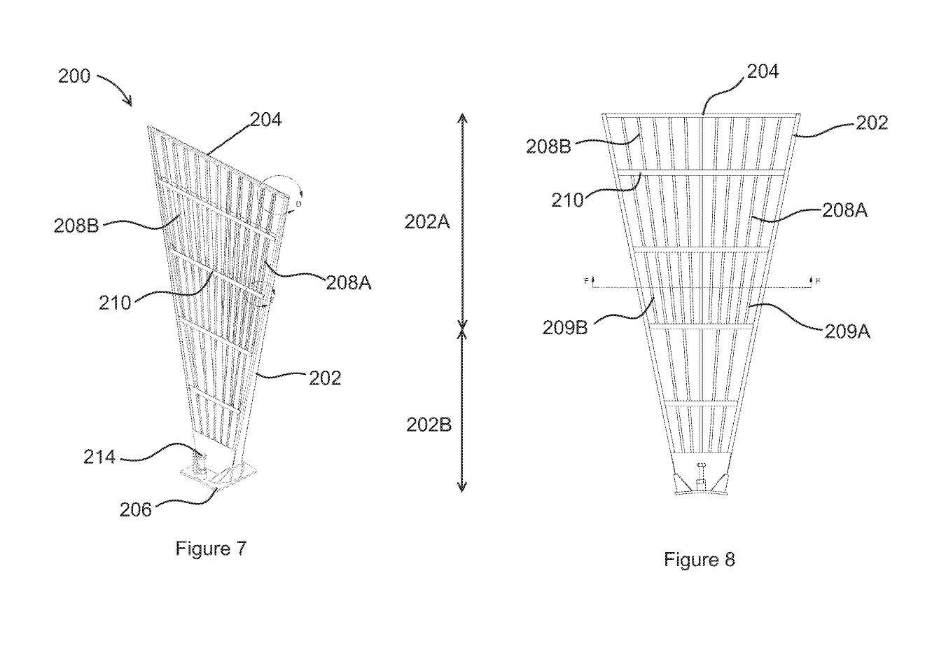

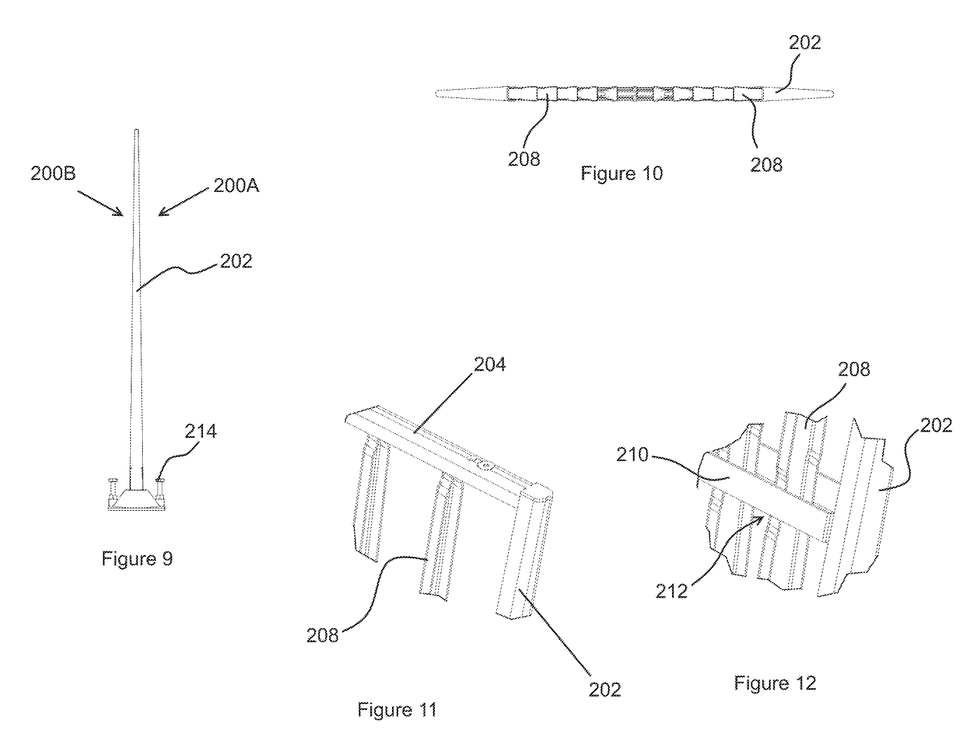

FIGS. 7 to 12, 21A and 21B illustrate a second embodiment of a disk segment. Such embodiment is typically adapted to receive a soft or at least flexible material filtering mean. The soft filtering mean may be embodied as a shrinking material membrane, such as a bag, or any other type of flexible membrane surface. The segment 200 comprises a frame, comprising two radial frame members 202 and a transversal frame member 204. Both extremities of the transversal frame member 204 are preferably each operatively connected to an extremity of a radial frame member 202. The radial frame members 202 are also preferably mounted on a support member, such as base plate 206 and form an angle 202′ varying with the number of segments in the disk.

The segment 200 also preferably comprises at least one radial rib 208 and at least one transversal rib 210. The radial rib 208 is preferably connected to the transversal frame member 204 and to the base plate 206. The transversal rib 210 is preferably connected to both radial frame members 202 to provide structural rigidity of the segment 200.

To further provide rigidity, it may be necessary to add supplementary radial ribs, or sub-ribs 209 in an upper portion 202A of the disk segment 200. The sub-ribs 209 preferably have a first extremity attached to the transversal frame member 204 and the other extremity attached to a transversal rib 210. The sub-ribs 209 preferably do not extend through the bottom portion 202B.

Referring to FIGS. 21A and 21B, an embodiment of the radial rib 208 preferably has a “U”-shape. Such shape aims at providing a better transportation of the liquid along the radial rib 108 since the channel defined by the “U”-shape substantially holds the particle therein.

To allow the segment 200 to be used in both directions of rotation, radial ribs 208A and sub-ribs 209A are typically disposed in an orientation opposite to radial ribs 208B and sub-ribs 209B such that at least one rib or sub-rib has its channel facing the direction of rotation.

In some embodiments, the segment 200 may be adapted to be used in only one direction (clockwise or counter-clockwise). In such embodiments, the channels must all be oriented in the same direction.

The radial frame members 202 preferably have a “U”-shape cross-section defining a cavity for receiving the extremities of the transversal ribs 210. The transversal frame member 204 also preferably has a “U”-shape cross-section defining a cavity for receiving the extremities of the radial ribs 208.

Referring more specifically to FIG. 12, the radial ribs 208 each preferably define a recess 212 whose depth substantially correspond to the thickness of the transversal ribs 210. Such recess allows the filtering surfaces 200A and 200B defined by the segment 200 to be substantially flat. Such embodiment aims at facilitating the installation of the mesh surface (not shown) on the filtering surfaces 200A and 200B and thus at improving the filtering efficiency of the segment 200.

The radial and transversal ribs 208-210 are preferably attached to the radial and transversal frame members 202 or 204 by any suitable means known in the art, such as, but not limited to, fastening, welding, or riveting. Also, the transversal ribs 210 may be attached at intermediate positions inside the recess 212 of the radial ribs 208 for better rigidity. Any mean known in the art may be used for that purpose.

Referring more specifically on FIG. 7, the plate 206 of the segment 200 is preferably mounted to a central axle using fasteners such as bolts 214.

It is to be noted that the segment may comprise more or less radial ribs 208 and more or less transversal ribs 210 than illustrated in the figures without departing from the scope of the present invention.

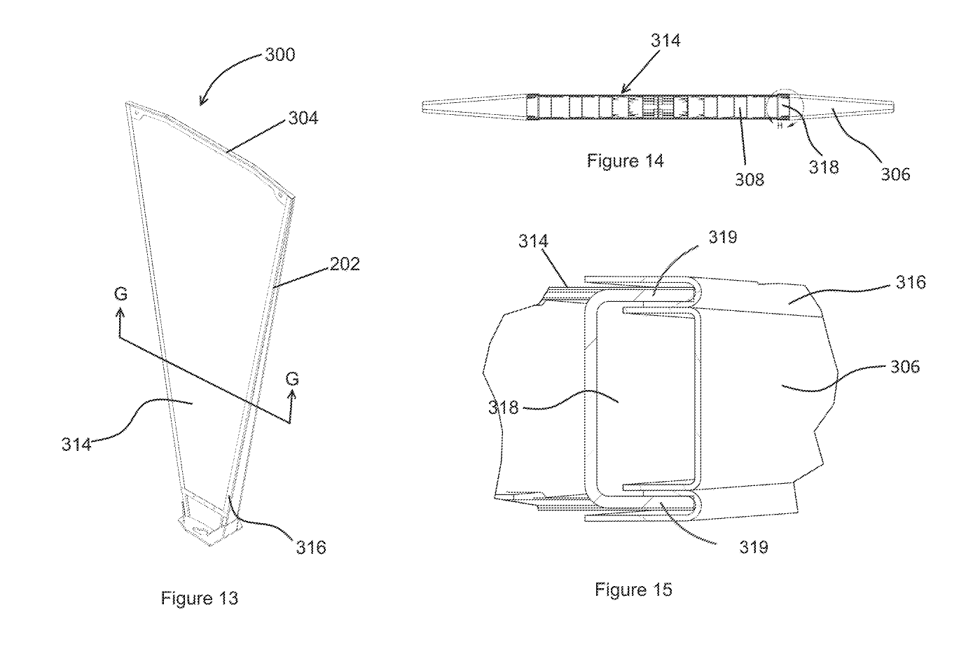

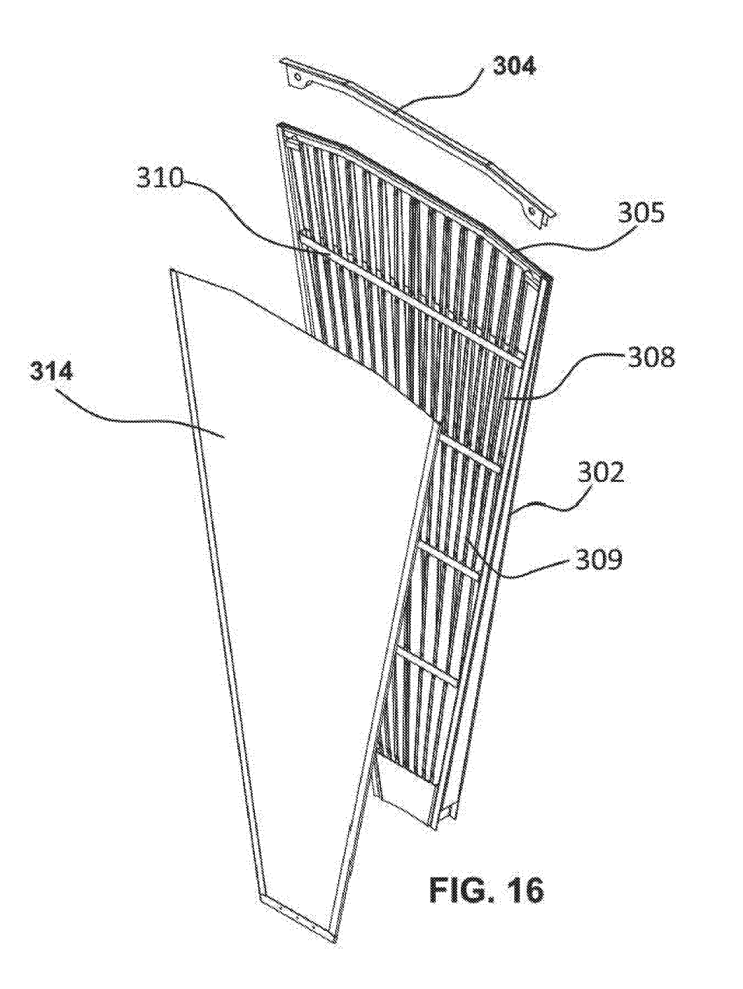

FIGS. 13 to 16 and 22 illustrate a method of attachment of a mesh to a disk segment. The segment 300, which in this case corresponds to the segment 200 illustrated in FIGS. 7 to 12, is adapted to receive a mesh surface 314 over the ribs 308, 309, and 10. The mesh surface 314 comprises radial mesh frame members 316 adapted to be received by the cavity of the “U-shaped” cross-section 318.

The attachment of the mesh 314 comprises sliding the mesh surface 314 over the ribs 308, 309 and 310 from the bottom of the segment radial structure member 302 toward the top of the structure member 302 as shown in FIG. 22. Typically, the radial mesh frame members 316 are slid over the leg portions 319 (shown as a U-shape cross-section) to keep the mesh surface 314 attached to the structure member 202.

The mesh surface 314 is then tensioned by sliding the radial mesh frame members 316 from the bottom of the segment radial structure member 202 toward the top of the structure member 202.

The radial mesh frame members 316 is then attached or fixed to the leg portions using but not limited to, fastening, welding, or riveting.

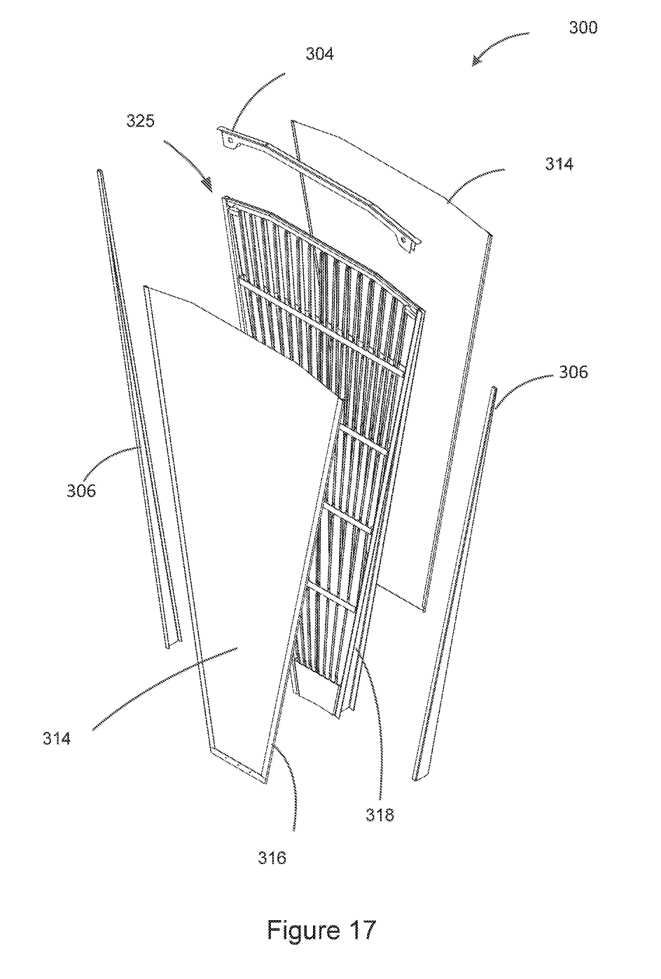

Optionally, a shown in FIG. 17, a covering member 306 may be clipped or fixed over the cross-section 318

FIG. 17 illustrates another exploded view of a segment 300, in accordance with at least one embodiment. As shown at FIG. 17, the mesh surfaces 314 may be attached on both sides of the frame 325 using the radial frame members 302 and the radial mesh frame members 316.

In at least one embodiment, a method to install the mesh surface 314 is shown in FIG. 22. In such an embodiment, the radial mesh frame members 316 may be attached to the mesh surface 314. For example, the radial mesh frame members 316 may be welded and/or soldered (for example, punctually welded) to the long sides of the mesh surface 314. Referring to FIG. 22, the mesh surface 314 may then be installed by sliding the radial mesh frame members 316 of the mesh surface 314 on to the segment 300 from the base plate 106 towards the transversal frame member 204. The radial mesh frame members 316 may thus hook on to the frame 325 (for example, on to the leg portions 319 of the cavity of the “U-shaped” cross-section 318, see, e.g., FIG. 15) and tighten the mesh surface 314 to the segment 300 when the mesh surface 314 is forced up in the direction from the base plate 106 towards the transversal frame member 204.

As shown at FIG. 15, the radial frame members 302 may further tighten the mesh to the frame 325, in particular to the leg portions 319 of the of the cavity of the “U-shaped” cross-section 318.

In at least one embodiment, the wire mesh surface 314 as described herein may be installed on the disk filter segment 300 to replace a nylon canvas and/or a cover bag, e.g., when the disk filter segment 300 may need to be repaired. Such replacement may be made possible using a sliding installation of the mesh surface 314 as described herein.

It should be noted that, typically in the industry, the mesh may be soldered or welded to the frame of the disk filter segment. Therefore, in such a case, when the mesh is damaged and/or has to be replaced, the whole disk filter segment needs to be replaced.

In contrast, the attachment of the mesh surfaces 314 as described herein may allow replacing and/or repairing the mesh surface 314 and then re-using the original frame 325 of the segment 300 with newly repaired/replaced mesh surfaces 314.

In at least one embodiment, the mesh surfaces 314 may be dismounted (disassembled) from the radial frame members 302. For example, referring again to FIGS. 13 to 17, to dismount the mesh surface 314 from the segment 300, one may free the radial frame member 302 from the cavity of the “U-shaped” cross-section 318, detach the transversal frame member 304 and slide down the radial mesh frame members 316 (in the direction from the transversal frame member 204 towards the base plate 106. Such dismountable attachment of the mesh surface 314 may be useful for repairing the segment 300 and/or replacing the mesh surface 314.

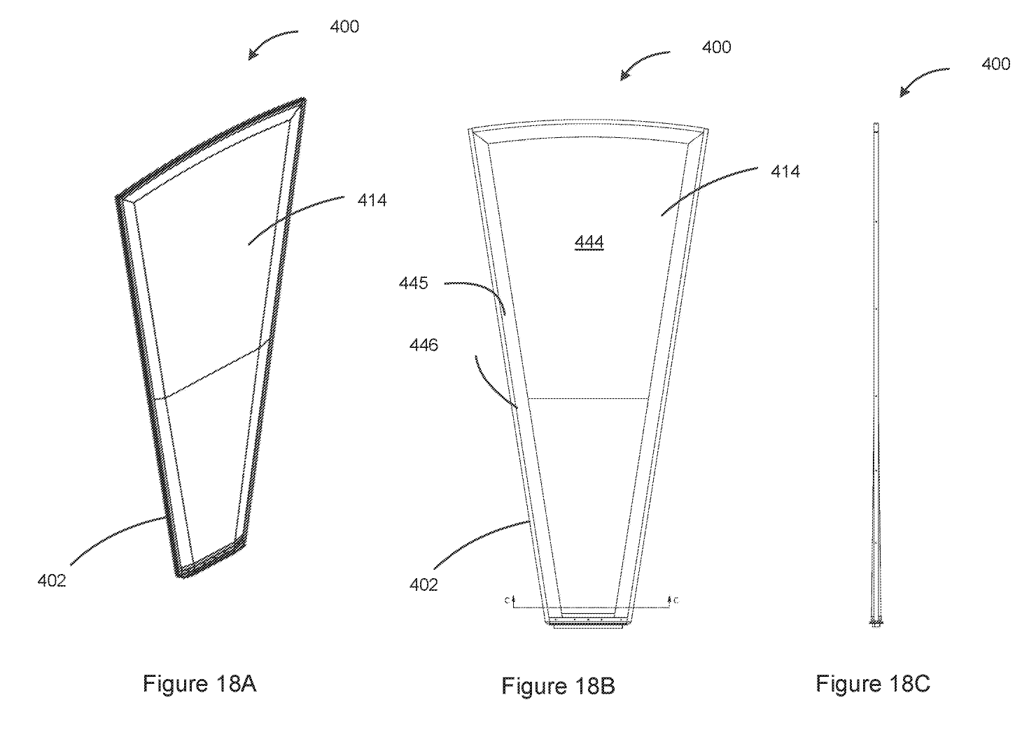

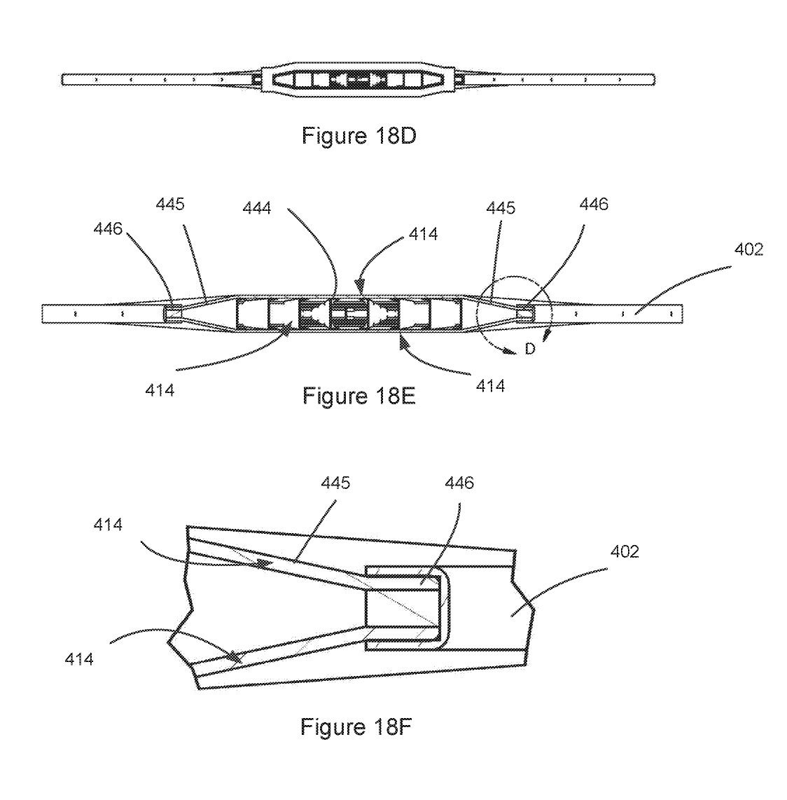

Referring now to FIGS. 18A, 18B, 18C, 18D, 18E, and 18F, another embodiment of a disk filter segment 400 is shown. In this exemplary embodiment, the mesh surface 414 has a generally convex form. In such an embodiment, the mesh surface 414 may comprise a central mesh portion 444, at least one mesh angled portion 445 and at least one mesh side portion 446. The dimensions of the mesh surface 414, dimensions of its portions 444, 445 and 446, and the dimensions of radial frame members 402 may be selected such that when the central mesh portion 444 is placed (positioned) on the mesh frame 425, the side portions 446 of two mesh surfaces 414 may be attached together. The side portions 446 of two mesh surfaces 414 may be attached with the radial frame members 402 as shown, in particular, at FIGS. 18E and 18F. The radial frame members 402 and the mesh surfaces 414 may be attached using means know in the art such as, but not limited to, spot welding, fastening or riveting.

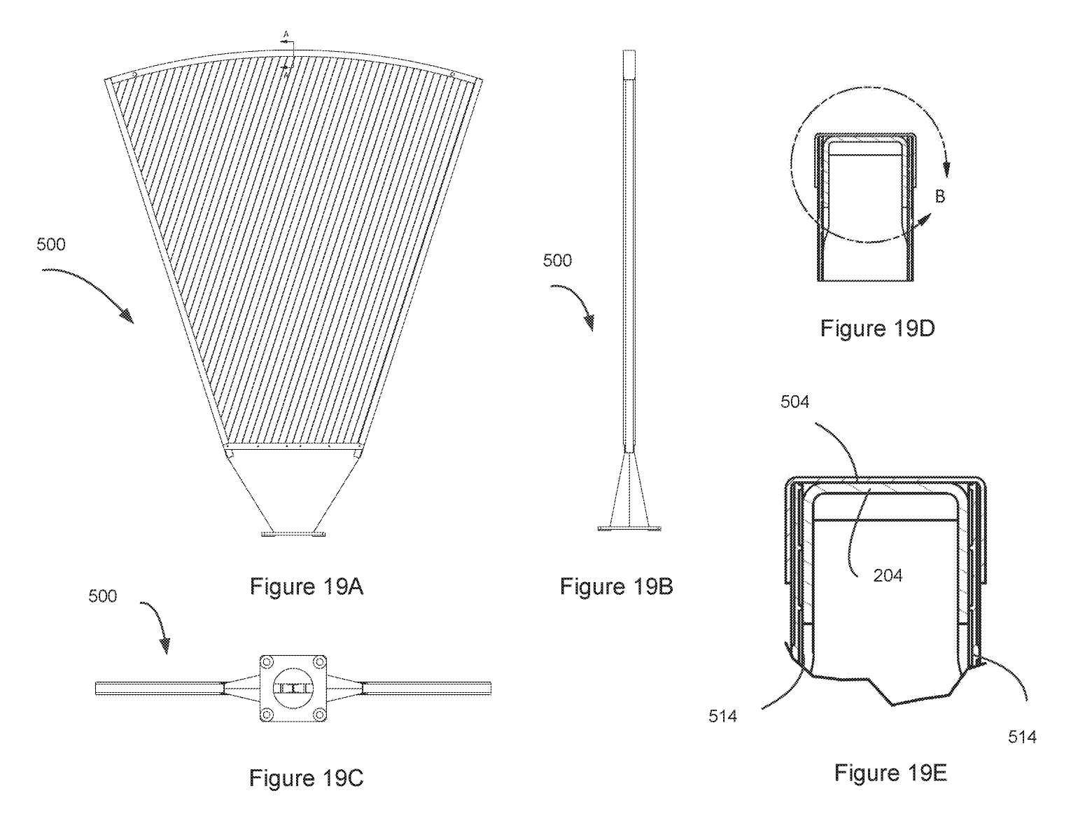

Shown at FIGS. 19A, 19B, 19C, 19D, and 19E is yet another embodiment of a disk filter segment 500. In particular, shown at FIG. 19E is an example of attachment of the mesh surfaces 514 to transversal frame member 204 using the attachable transversal frame member 504. In such an embodiment, the frame member 504 is installed over and generally covers the extremity of the transversal frame member 204 and of the mesh surfaces 514. Again, the frame members 504 and the mesh surfaces 514 may be attached using means know in the art such as, but not limited to, spot welding, fastening or riveting.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A disk filter segment adapted to be mounted to an axle of a rotary filter, the disk filter segment comprising:
a frame comprising:
a base portion adapted to be mounted to the axle;
at least one rib, radially extending from the base portion, the rib defining a channel for guiding liquid toward the axle;
two frame members radially extending from the base portion;
at least one filtering member comprising:
two side structure members, each side structure being connected to the two frame members;
a filtering element extending between the two side structure members.

2) The disk filter segment of claim 1, the side structure members being adapted to slide in at least one of the frame members.

3) The disk filter segment of claim 2, the side structure members being attached to the at least one frame member.

4) The disk filter segment of claim 2, the side structure members being attached to the at least one frame member using any one of spot welding, fastening or riveting.

5) The disk filter segment of claim 1, the frame members comprising two legs, each leg being adapted to receive a side structure member.

6) The disk filter segment of claim 3, the frame members being U-shaped.

7) The disk filter segment of claim 1, the disk filter segment further comprising a transversal frame member adapted to attach the top of the at least one filtering member to the top of the frame.

8) The disk filter segment of claim 1, the disk filter segment further comprising a transversal frame member adapted to attach the top of the at least one filtering member to the top of the frame.

9) The disk filter segment of claim 1, the disk filter segment further comprising a covering member adapted to be attached over an outer radial rib.

10) The disk filter segment of claim 1, the frame further comprises at least one inner transversal frame members extending from one outer radial rib to another of the frame members.

11) The disk filter segment of claim 10, each radial rib comprising a recess adapted to receive one of the transversal frame members.

12) The disk filter segment of claim 11, each recess having a depth substantially matching the thickness of the transversal frame members.

13) The disk filter segment of claim 10, the frame further comprising at least one rib radially extending from one of the inner transversal frame member, each rib defining a channel for guiding liquid toward the axle.

14) The disk filter segment of claim 10, the transversal frame members extending from the outer radial rib at an angle of about 90 degrees.

15) The disk filter segment of claim 1, the filtering cover being a mesh.

16) The disk filter segment of claim 15, the mesh being made of semi-rigid material.

17) The disk filter segment of claim 15, the mesh being made of metal.

18) The disk filter segment of claim 1, the rib having a “Z”-shape cross-section.

19) The disk filter segment of claim 1, the rib having a “U”-shape cross-section.

20) The disk filter segment of claim 1, the disk filter segment comprising two filtering member adapted to be mounted on each side of the frame.

21) The disk filter segment of claim 15, the mesh being attached to the frame of the disk filter segment.

22) The disk filter segment of claim 21, the mesh being attached to the frame using anyone one of spot welding, fastening or riveting.

23) A method for installing a filter member of a disk filter segment, the method comprising:
placing side structure members of the filtering member over outer ribs of a frame of the disk filter segment adapted to mate with side structure members;
tensioning the filtering member to the frame;
attaching the placed side structure members to the outer ribs.

24) The method for installing a filter member of claim 23, the tensioning of the filtering member further comprising sliding the side structure members over the outer ribs from a base portion of the frame toward a top portion of the frame.

25) The method for installing a filter member of claim 23, the attaching of the side structure members further comprising spot welding.

26) The method for installing a filter member of claim 23, the method further comprising installing a covering member over the attached side structure members.

27) The method for installing a filter member of claim 23, the method further comprising installing a covering member over the attached side structure members.

28) The method for installing a filter member of claim 23, the method further comprising attaching top of the at least one filtering member to the top of the frame using a transversal frame member.

29) The method for installing a filter member of claim 23, the method further attaching inner portion of the filtering member to inner transversal members or to ribs of the frame.

30) The method for installing a filter member of claim 29, the ribs comprising recess having a depth about the same as thickness of the inner transversal members, the recess being adapted to receive the inner transversal members.

31) The method for installing a filter member of claim 23, the method further comprising:
removing the disk filter segment from a shaft;
removing the filtering member from the frame of the disk filter segment.
